(19) United States
(12) Patent Application Publication
(10) Pub. No.: US 2003/0084007 A1
(43) Pub. Date: May 1, 2003

(54) Postage stamps authenticating the sender of a mail piece, and methods for use therewith

(76) Inventor: George Brookner, Norwalk, CT (US)

Correspondence Address: Oppedahl &, Larson LLP, P O Box 5068, Dillon, CO, 80435-5068, US

(21) Appl. No.: 09/683,426

(22) Filed: Dec. 27, 2001

Related U.S. Application Data
(60) Provisional application No. 60/340,028, filed on Oct. 29, 2001.

(51) Int. Cl. G06F 17/00

(52) U.S. Cl. 705/408; 705/410

(57) ABSTRACT

### Abstract of Disclosure

A would-be purchaser of postage stamps is required to provide information indicative of his or her identity, for example by means of an identity code. The identity code is then imprinted upon the stamps and the stamps are then provided to the purchaser. The imprint may be a bar code, and the imprinted information may be cryptographically signed. The imprinted information may be printed in such as way as to be invisible to the naked eye.

### Cross Reference to Related Applications

This application claims priority from U.S. appl. no. 60/340,028 filed October 29, 2001.

### Background of Invention

For a number of reasons, a postal carrier receiving mail pieces might wish to know the identity of the sender of the mail pieces. This is not always easy to determine, especially when the mail pieces are deposited in a drop box. As an alternative, the postal carrier might instead choose to require that it know the identity of the purchaser of the postage stamps attached to the mail pieces.

Similarly, a recipient of mail pieces might wish to know the identity of the sender of the mail pieces, or in the alternative might wish to know the identity of the purchaser of the postage stamps attached to the mail pieces.

These inquiries by a postal carrier or by a recipient may be motivated by a desire to be cautious about the possibility of a mail piece being dangerous.

The mere existence and use of such a system might well reduce the incidence of dangerous mail pieces.

A number of efforts have been made to provide opportunities for customizing postage stamps. U.S. Pat. No. 5,717,597 to Kara shows a system in which a user is able to print IBIP-style postage with fanciful personalized information, for example to be used in connection with a greeting card. U.S. Pat. No. 5,923,406 to Brasington et al. and U.S. Pat. No. 5,873,605 to Kaplan each propose a postage stamp bearing a photograph of a user. U.S. Pat. No. 5,423,573 to de Passilléshows a kit providing adhesive pieces that may be stacked or assembled to provide postage stamps that include user-selected portions. None of these systems, however, involves a precondition, prior to purchase of postage indicia, of receiving information indicative of the identity of the purchaser. Likewise none of these systems involves a precondition, prior to receiving a mail piece, of the mail piece bearing an indicium bearing information indicative of the identity of the purchaser. Finally, none of these systems puts a recipient of mail pieces in a position to identify the sender for each mail piece.

Many mail pieces are franked using postage stamps. In contrast, some mail pieces are franked using a postage meter (franking machine). It will be appreciated that in many countries (including the U.S.) a postal indicium printed by a postage meter necessarily carries a "meter number"which can be traced, through post office records, back to the user of the postage meter. If such a meter is taken out of service and provided to a different user, its meter number may well stay unchanged. From this it will be appreciated that the meter number is not necessarily directly indicative of the identity of its user, but may be only indirectly indicative thereof, through consultation of post office records.

At least one postal authority has devised so-called "IBIP"(information-based indicia program) indicia. Such indicia carry a number of items of information, many of which are cryptographically signed and printed by means of a two-dimensional bar code. With such an indicium, the entirety of the indicium is printed at once and by a single printing process. Such indicia are generally dated and must be used promptly.

For many postal patrons, adhesive postage stamps are very convenient. They are not dated in a way that requires their use on a particular date, and they may thus be used on whatever date the patron wishes to use them.

It would thus be extremely desirable to have a system and method for using postage stamps which permits the flexibility of use on such date as a sender may choose, and yet which permit knowing the identity of a sender of mail pieces or of a purchaser of the stamps.

### Summary of Invention

A would-be purchaser of postage stamps is required to provide information indicative of his or her identity, for example by means of an identity code. The identity code is then imprinted upon the stamps and the stamps are then provided to the purchaser. The imprint may be a bar code, and the imprinted information may be cryptographically signed. The imprinted information may be printed in such as way as to be invisible to the naked eye.

### Brief Description of Drawings

The invention will be described with respect to a drawing in several figures, of which:

Fig. 1 shows two exemplary postage stamps according to the invention;

Fig. 2 is a flow chart showing steps in purchasing postage stamps according to the invention; and

Fig. 3 shows an apparatus for printing information on postage stamps.

### Detailed Description

As described in more detail below, to identify a purchaser of postage stamps from a postage stamp providing entity, the postage stamp purchase would require the purchaser to enter or provide an identity code. The code would be imprinted onto the stamp(s) prior to delivery to the purchaser. In this way, the system can provide a mechanism to identify the purchaser of postage stamps or other identity item, which becomes affixed to some item (such as a mail piece) as a notification of payment or authenticity. As in a bank where deposit receipts are machine printed for a customer, so would the postage stamps purchased by a user be machine-printed.

In a typical arrangement, the system would provide a postage stamp with a small portion of the stamp being blank, wherein the blank area would be imprinted an with an identity bar code representative of the stamp purchaser. the postage stamp would receive upon its face an invisibly printed bar code representative of the stamp purchaser. The bar code could be encrypted and/or signed for identity protection and to inhibit fraud. Typical of this mechanism is the incorporation of Public Key encryption.

As described below, a bar code printing machine will imprint the bar codes. At the point of purchase, the stamp(s), stamp booklet(s), stamp roll(s) will be run through the bar code printing machine, much the same as a bank teller inserts a deposit receipt into a printer to have customerdeposit information printed. The bar code printer of this invention will preferably be calibrated to accept single stamps, flats of stamps, stamp booklets, and stamp rolls. The customer enters, or has entered his or her password or password-like identification and the barcode printer will customize the stamp purchase to convey the customer's identity. Typical of a barcode to imprint (visibly or invisibly) onto the postage stamp is that of a two-dimensional construct, typified by a Data Matrix graphic.

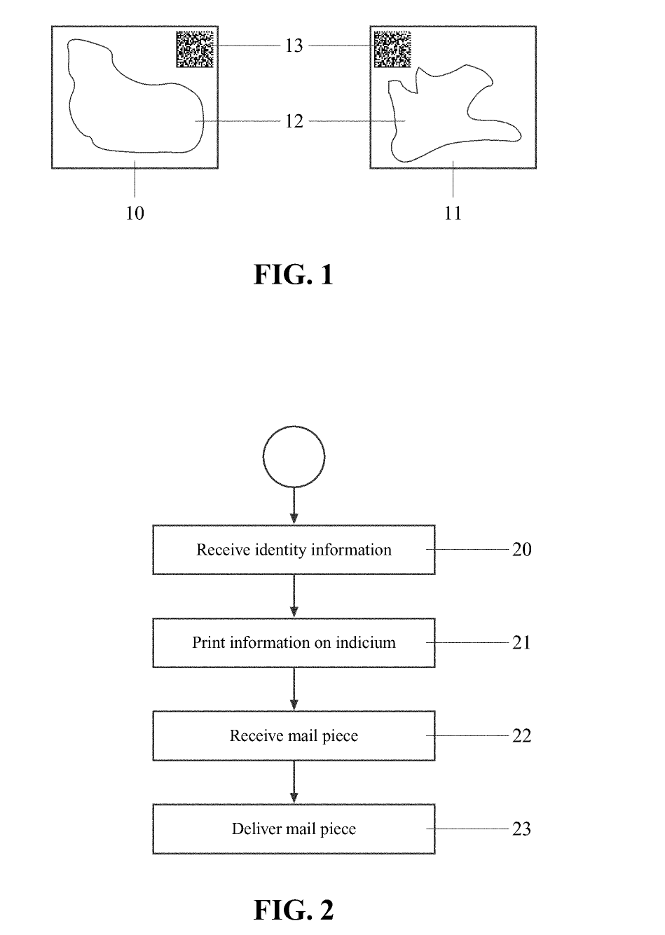

Turning now to Fig. 1, what is shown are two exemplary postage stamps 10, 11 according to the invention. Each postage stamp has an area 12 for text and artwork, and after printing of the bar code, has a bar code 13. Before the bar code 13 is printed, there is a blank area to receive the bar code 13. In a typical arrangement, an adhesive postal indicium will comprise information indicative of a postage amount printed by a first process, information indicative of a country printed by the first process; and cryptographically signed information indicative of an identity of a purchaser of the adhesive postal indicium, the cryptographically signed information printed by a different process than the first process. A plurality of such indicia may be provided to a purchaser.

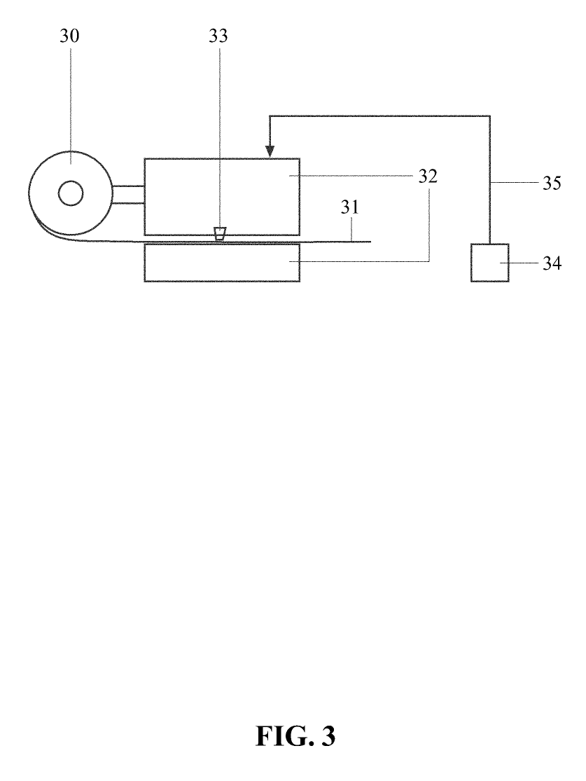

Fig. 3 shows an apparatus 32 for printing information on postage stamps. A spool of stamps 30 is preferably provided, which pass by a printer 33 and exit at 31. The purchaser of the stamps provides identifying information at terminal 34. This may comprise inserting an identification card into a reader, entering a PIN (personal identification number), or both. Identifying information is passed along communications line 35, and drives printer 33.

An exemplary printing apparatus may thus comprise a plurality of adhesive postal indicia, each postal indicium comprising information indicative of a postage amount and information indicative of a country, each postal indicium free of any cryptographically signed information indicative of an identity of a purchaser of the postal indicia; and a printer adapted to print upon the plurality of adhesive postal indicia cryptographically signed information indicative of an identity of a purchaser of the adhesive postal indicia.

An exemplary method for use with such a printing apparatus comprises the steps of receiving information indicative of an identity of a purchaser of the adhesive postal indicia, cryptographically signing the information indicative of the identity of the purchaser of the adhesive postal indicia, and printing upon the adhesive postal indicia, by means of the printer, information indicative of the cryptographically signed information.

Fig. 2 is a flow chart showing steps in purchasing postage stamps according to the invention. At 20, the post office receives information indicative of the identity of a purchaser of postage stamps. At 21, a printing device prints information on the indicium. At 22, the post office receives the mail piece. At 23, the post office delivers the mail piece.

An exemplary method proceeds as follows. The post office requires, as a precondition of purchasing at least one postal indicium, receipt of first information indicative of the purchaser's identity. Second information is functionally derived from the first information. The second information may for example comprise a bar code bitmap, or a cryptographically signed block of data. The second information is printed on the indicium. The post office receives the mail piece and delivers it.

In the case considered to be most common, the postal indicium is an adhesive postage stamp. It could in some circumstances be a meter strip, or be printed on an envelope or post card. The printed information may, as mentioned above, be visible or invisible.

In a related method, the precondition might not bar selling the stamps (in the absence of identity information), but might instead bar the receipt of the mail pieces into the distribution system of the post office. In such a case a cryptographic signature permits confirming the authenticity of the markings.

In still another method, a recipient of mail pieces would receive the mail piece, would read the information indicative of the identity of the sender; and would determine whether the sender whose identity is indicated by the information is an expected sender. If necessary, the mail piece could be investigated further, for example for presence of hazards.

Those skilled in the art will have no difficulty devising myriad variations and obvious improvements, all of which are intended to be encompassed within the scope of the claims which follow.

Claims

1. A method for use with mail pieces and with a purchaser having an identity, the method comprising the steps of:
requiring, as a precondition of purchasing at least one postal indicium, receipt of first information indicative of the purchaser's identity,
deriving second information functionally from said first information;
printing said second information upon the at least one postal indicium;
receiving an addressed mail piece with the at least one postal indicium into the mail; and
delivering the addressed mail piece.

2. The method of claim 1 wherein the postal indicium is an adhesive postage stamp.

3. The method of claim 1 wherein the postal indicium is a meter strip.

4. The method of claim 1 wherein the postal indicium is printed on an envelope.

5. The method of claim 1 wherein the postal indicium is printed on a post card.

6. The method of claim 1 wherein the second information is an invisibly printed bar code.

7. The method of claim 1 wherein the second information is a visibly printed bar code.

8. The method of claim 1 wherein the second information is a human-readable message.

9. The method of claim 1 further characterized in that the number of postal indicia comprise a plurality, and wherein the printing, receiving, and delivering steps are carried out with respect to each of the plurality of indicia.

10. A method for use with purchased postal indicia, with mail pieces and with a purchaser having an identity, the method comprising the steps of:
requiring, as a precondition of receiving at least one addressed mail piece with a postal indicium into the mail, that the postal indicium bear information indicative of the identity of the purchaser;
receiving the at least one addressed mail piece with the postal indicium into the mail; and
delivering the at least one addressed mail piece.

11. The method of claim 10 wherein the postal indicium is an adhesive postage stamp.

12. The method of claim 10 wherein the postal indicium is a meter strip.

13. The method of claim 10 wherein the postal indicium is printed on an envelope.

14. The method of claim 10 wherein the postal indicium is printed on a post card.

15. The method of claim 10 wherein the second information is an invisibly printed bar code.

16. The method of claim 10 wherein the second information is a visibly printed bar code.

17. The method of claim 10 wherein the second information is a human-readable message.

18. The method of claim 10 further characterized in that the number of addressed mail pieces comprise a plurality, and wherein the printing, receiving, and delivering steps are carried out with respect to each of the plurality of addressed mail pieces.

19. The method of claim 10 further characterized in that the information indicative of the identity of the purchaser is cryptographically signed, the precondition further characterized as requiring successful checking of the cryptographic signature.

20. A method for use with purchased postal indicia, with mail pieces and with a purchaser having an identity, the method comprising the steps of:
requiring, as a precondition of delivering at least one addressed mail piece with a postal indicium, that the postal indicium bear information indicative of the identity of the purchaser;
receiving the at least one addressed mail piece with the postal indicium into the mail; and
delivering the at least one addressed mail piece.

21. The method of claim 20 wherein the postal indicium is an adhesive postage stamp.

22. The method of claim 20 wherein the postal indicium is a meter strip.

23. The method of claim 20 wherein the postal indicium is printed on an envelope.

24. The method of claim 20 wherein the postal indicium is printed on a post card.

25. The method of claim 20 wherein the second information is an invisibly printed bar code.

26. The method of claim 20 wherein the second information is a visibly printed bar code.

27. The method of claim 20 wherein the second information is a human-readable message.

28. The method of claim 20 further characterized in that the number of addressed mail pieces comprise a plurality, and wherein the printing, receiving, and delivering steps are carried out with respect to each of the plurality of addressed mail pieces.

29. The method of claim 20 further characterized in that the information indicative of the identity of the purchaser is cryptographically signed, the precondition further characterized as requiring successful checking of the cryptographic signature.

30. A method for use with mail pieces and with a recipient possessing a list of expected senders, and with a sender having an identity, the method comprising the steps of:
receiving a delivered mail piece bearing a postal indicium, the postal indicium bearing information indicative of the identity of the sender;
reading the information indicative of the identity of the sender; and
determining whether the sender whose identity is indicated by the information is on the list of expected senders.

31. The method of claim 30 further characterized in that the information indicative of the identity of the sender that is borne in the postal indicium is cryptographically signed, and further characterized in that the reading step further comprises checking the cryptographic signature.

32. The method of claim 30 comprising the additional step, performed in the event of the sender not being on the list of expected senders, of inspecting the delivered mail piece.

33. An adhesive postal indicium comprising:indicative of a postage amount printed by a first process;
information indicative of a country printed by the first process; and
cryptographically signed information indicative of an identity of a purchaser of the adhesive postal indicium;
the cryptographically signed information printed by a different process than the first process.

34. A plurality of adhesive postal indicia, each postal indicium comprising:
information indicative of a postage amount printed by a first process;
information indicative of a country printed by the first process; and
cryptographically signed information indicative of an identity of a purchaser of the adhesive postal indicia;
the cryptographically signed information printed by a different process than the first process.

35. Printing apparatus comprising:
a plurality of adhesive postal indicia, each postal indicium comprising information indicative of a postage amount and information indicative of a country, each postal indicium free of any cryptographically signed information indicative of an identity of a purchaser of the postal indicia; and
a printer adapted to print upon the plurality of adhesive postal indicia cryptographically signed information indicative of an identity of a purchaser of the adhesive postal indicia.

36. A method for use with printing apparatus comprising a plurality of adhesive postal indicia, each postal indicium comprising information indicative of a postage amount and information indicative of a country, each postal indicium free of any cryptographically signed information indicative of an identity of a purchaser of the postal indicia, and a printer adapted to print upon the plurality of adhesive postal indicia, the steps of:
receiving information indicative of an identity of a purchaser of the adhesive postal indicia;
cryptographically signing the information indicative of the identity of the purchaser of the adhesive postal indicia;
printing upon the adhesive postal indicia, by means of the printer, information indicative of the cryptographically signed information.
